(19) United States
(12) Patent Application Publication
(10) Pub. No.: US 2017/0104899 A1
(43) Pub. Date: Apr. 13, 2017

(54) TRACKING CAMERA STAND BASE

(71) Applicant: Oculus VR, LLC, Menlo Park, CA (US)

(72) Inventors: Peter Wesley Bristol, Seattle, WA (US); David Michael Pickett, Seattle, WA (US)

(21) Appl. No.: 14/877,833

(22) Filed: Oct. 7, 2015

(51) Int. Cl. H04N 5/225

(52) U.S. Cl. CPC H04N 5/2251

(57) ABSTRACT

Stand bases for tracking cameras are disclosed herein. In various embodiments, a tracking camera assembly includes a camera head, a stand pole extending away from the camera head, and a stand base configured to receive the stand pole. The stand base includes a cylindrical body having a top surface, a bottom surface, and a side surface, the cylindrical body defining an axis extending between the top surface and the bottom surface. An axial bore is formed in the top surface of the cylindrical body, the axial bore configured to removably receive a portion of the stand pole therein. A radial bore is formed in the side surface of the cylindrical body, the radial bore configured to removably receive a portion of the stand pole therein. A recess formed in the bottom surface of the cylindrical body is configured to receive an adhesive therein.

### TECHNICAL FIELD

This patent application is directed to stand bases and, more specifically, to stand bases for tracking cameras.

### BACKGROUND

Tracking cameras are configured to be moveable to follow a target or to capture desired fields of view over time. Tracking cameras are often mounted to a stand base that rests on a horizontal surface, for example a table or counter top. There is a need for a versatile assembly that allows the tracking camera to be positioned in various different configurations with respect to the stand base.

### BRIEF DESCRIPTION OF THE DRAWINGS

Embodiments of the tracking camera stand base introduced herein may be better understood by referring to the following Detailed Description in conjunction with the accompanying drawings, in which like reference numerals indicate identical or functionally similar elements:

FIG. 1 is an isometric view of a tracking camera assembly with the stand base in a horizontal configuration in accordance with an embodiment of the present technology.

FIG. 2 is a perspective view of the tracking camera assembly of FIG. 1 with the stand base separated from the stand pole.

FIG. 3 is a perspective view of the tracking camera assembly of FIG. 1 with the stand base separated from the stand pole and in a vertical configuration in accordance with an embodiment of the present technology.

FIG. 4A is a top plan view of a stand base in accordance with an embodiment of the present technology.

FIG. 4B is a side view of the stand base of FIG. 4A.

FIG. 4C is a front view of the stand base of FIGS. 4A and 4B.

FIG. 4D is a perspective view of the stand base of FIGS. 4A-4C.

The headings provided herein are for convenience only and do not necessarily affect the scope or meaning of the claimed embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to limit the embodiments described. On the contrary, the embodiments are intended to cover all modifications, equivalents, and alternatives falling within the scope of the embodiments.

### DETAILED DESCRIPTION

### Overview

A stand base for a tracker camera is disclosed. The stand base is a disc-shaped or other similar body having a central axially extending mounting bore configured to receive a stand pole. The stand base also includes a radially extending mounting bore configured to receive the stand pole. Accordingly, the stand pole can be positioned in either the axial bore or the radial bore depending on the desired mounting arrangement. When the stand pole is positioned in the axial bore the tracker camera can be placed on horizontal surfaces. When the stand pole is positioned in the radial bore the stand base can be mounted to angled or vertical surfaces such as walls, televisions, etc. In some embodiments, the stand base includes a recess to receive a double sided adhesive for mounting to angled or vertical surfaces.

### General Description

Various examples of the devices introduced above will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

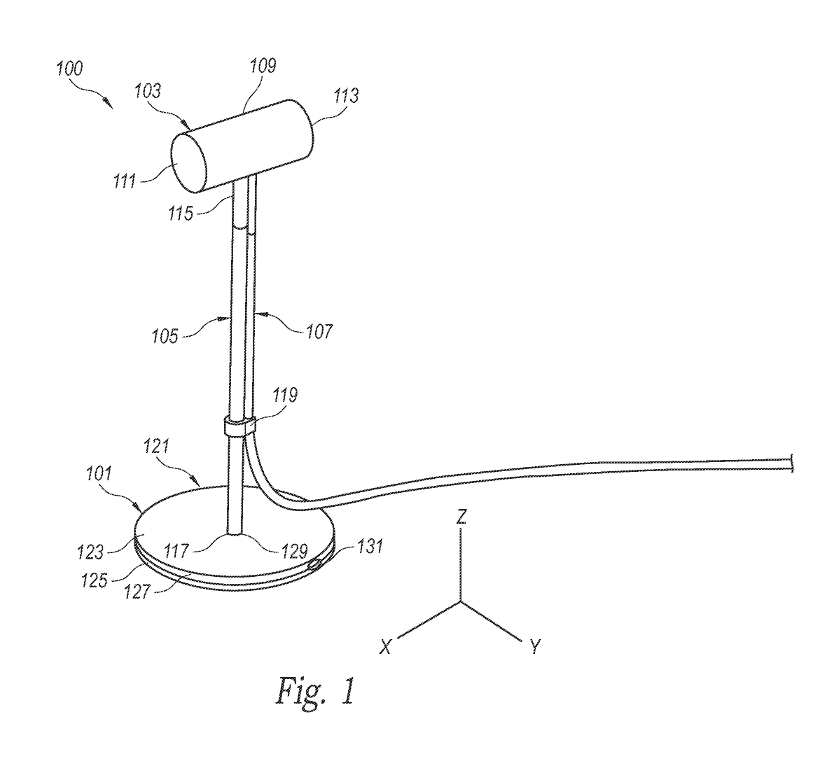

FIG. 1 is an isometric view of a tracking camera assembly 100 with a stand base 101 in a horizontal configuration in accordance with an embodiment of the present technology. The assembly 100 includes the stand base 101, a camera head 103, and a stand pole 105 extending between the stand base 101 and the camera head 103. An electrical and/or communication cable 107 extends away from the camera head 103 and along the stand pole for a portion of its length.

The camera head 103 includes a substantially cylindrical body 109 having a first end 111 and a second end 113. The camera head 103 can include optics and associated camera electronics (not shown) to allow the camera head 103 to capture images viewed through the first end 111. The cable 107 is in electrical communication with the camera head 103 and provides control and data communication. The camera head 103 can be configured to move with respect to the stand pole 105 with at least one degree of freedom. For example, in some embodiments the camera head 103 can pivot or rotate about the y-axis, thereby obtaining varying fields of view depending on the arrangement and position of the camera head 103 with respect to the stand pole 105. Additionally, in some embodiments the stand pole 105 can rotate about the z-axis with respect to the stand base, thereby allowing additional variation in the field of view captured by the camera head 103.

The stand pole 105 is an elongate rod having a first end 115 coupled to the camera head 103 and a second end 117 coupled to the stand base 101. As described in more detail below, the second end 117 of the stand pole 105 is configured to be removably coupled to the stand base 101. A clamp 119 can secure the cable 107 to the stand pole 105. The clamp 119 can be configured to slide along the length of the stand pole 105 to secure the cable 107 at any desired position along the stand pole 105.

The stand base 101 includes a cylindrical or disc-shaped body 121 having an upper surface 123, a lower surface 125, and a side surface 127 extending between the upper surface 123 and the lower surface 125. An axial bore 129 is formed in the upper surface 123 of the stand base 101. The axial bore 129 is disposed substantially centrally with respect to the upper surface 123 of the stand base 101 and extends substantially perpendicularly with respect to the upper surface 123. In other embodiments, the axial bore 129 can be disposed at other positions along the upper surface of the stand base 101 and in other orientations, for example at an angle with respect to the upper surface 123. In other embodiments, the stand base can assume other shapes, for example square, rectangular, oval, a rectangular prism, a semi-spherical shape with a flattened lower surface, etc. In some embodiments of the stand base, the transition between the upper surface and the side surface may be smooth (e.g., an ellipsoid with a flattened bottom), in which case both the axial bore and the radial bore may both be formed in the same surface, though in different areas of the surface.

A radial bore 131 is formed in the side surface 127 of the stand base 101. The radial bore 131 is disposed substantially centrally with respect to the side surface 127 and extends substantially perpendicularly with respect to the side surface 127. In other embodiments, the radial bore 131 can be disposed at other positions along the side surface 127 (e.g., closer to either the upper surface 123 or the lower surface 125) and at other orientations (e.g., at an angle with respect to the side surface 127). In some embodiments, a plurality of radial bores 131 can be provided around the side surface 127. In some embodiments, the axial bore 129 and/or the radial bore 131 can be blind holes, while in other embodiments the axial bore 129 and/or the radial bore 131 can be through holes.

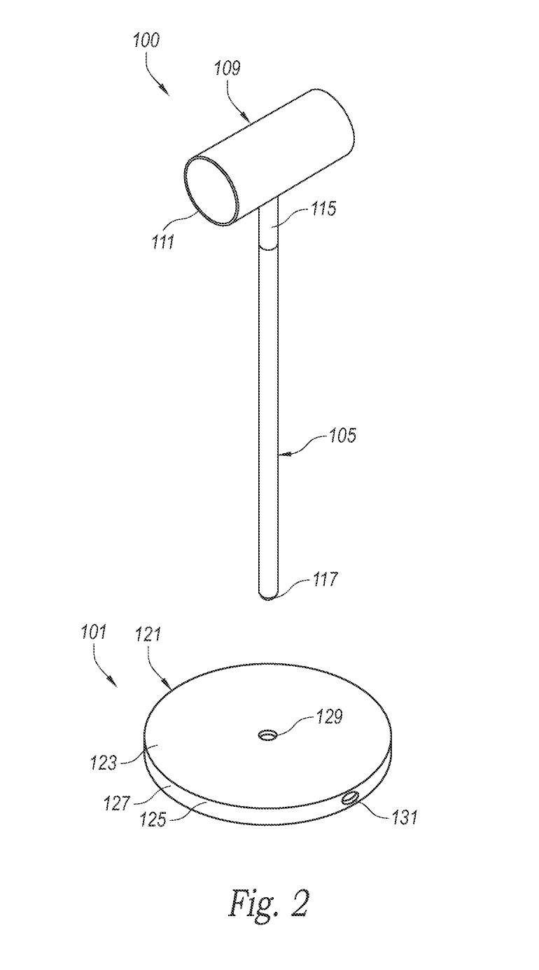

FIG. 2 shows the assembly 100 of FIG. 1 with the stand base 101 separated from the stand pole 105. The cable 107 is not shown for simplicity. As noted above, the second end 117 of the stand pole 105 is configured to removably engage with the axial bore 129 of the stand base 101. In some embodiments, the axial bore 129 can have threaded grooves and the second end 117 of the stand pole 105 can include corresponding threads. In other embodiments, the axial bore 129 and the second end 117 of the stand pole 105 can be dimensioned so that the second end 117 is received within the axial bore 129 via a friction fit. Once the second end 117 of the stand pole 105 is engaged with the axial bore 129, it can be readily disengaged to move assembly to a second arrangement in which the stand pole 105 is engaged with the radial bore 131, as described in more detail below.

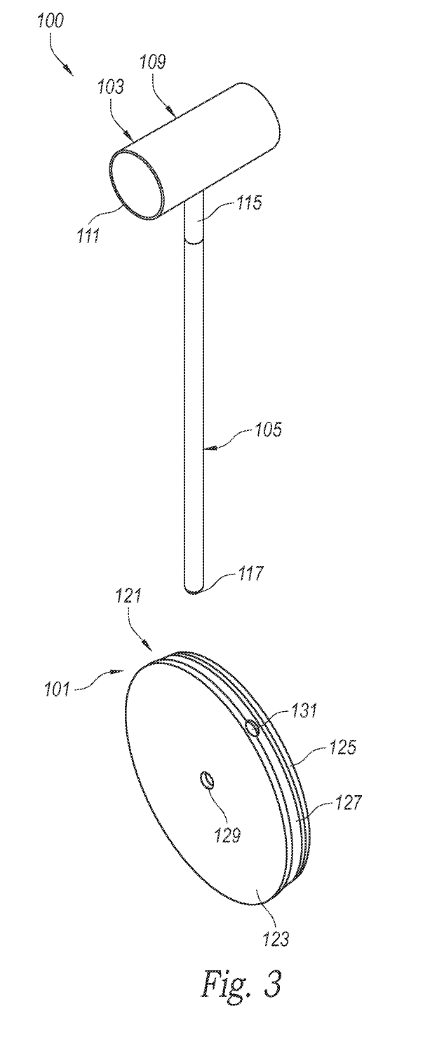

FIG. 3 shows the assembly 100 of FIG. 1 with the stand base 101 separated from the stand pole 105, except that the stand base 101 is substantially parallel with respect to the stand pole 105. The second end 117 of the stand pole 105 is configured to removably engage with the radial bore 131 of the stand base 101. In various embodiments, the radial bore 131 threadably engages the second end 117 of the stand pole 105, or the radial bore 131 and the second end 117 of the stand pole 105 can be coupled via a friction fit.

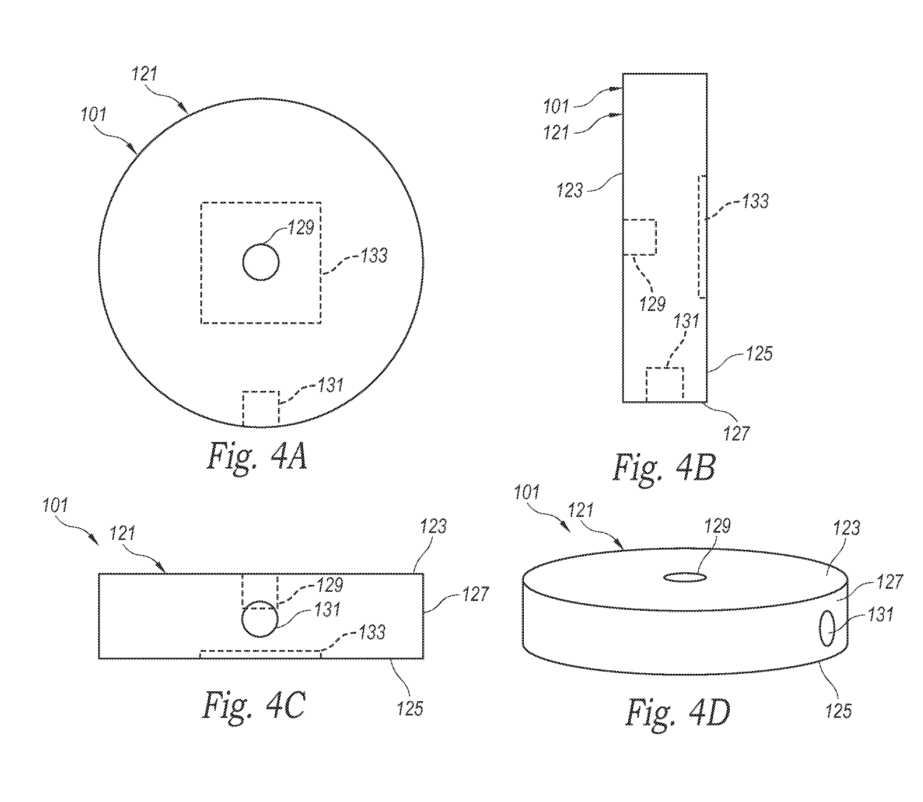

FIGS. 4A-4D are top, side, front, and perspective views, respectively, of the stand base 101 in accordance with an embodiment of the present technology. As illustrated, the stand base 101 includes a cylindrical or disc-shaped body 121 having upper surface 123, lower surface 125, and side surface 127 extending between the two. The axial bore 129 is formed in the upper surface 123 and the radial bore 131 is formed in the side surface 127. A recess 133 is formed in the lower surface 125 of the stand base 101. The recess 133 is configured to receive an adhesive therein, for example double-sided tape or other similar adhesive. The recess 133 is illustrated as a square-shaped recess, however the size and shape can vary depending on the intended adhesive and other properties. In some embodiments, the adhesive can be re-usable, such that the stand base 101 can be secured to a surface via the adhesive in the recess 133, and later removed and mounted to a different surface using the same adhesive.

The assembly 100, and in particular the stand base 101, allows for different arrangements of the stand pole 105 and camera head 103 with respect to the stand base 101. As noted above, the second end 117 of the stand pole 105 is configured to be removably received within both the axial bore 129 and the radial bore 131. This provides two different arrangements for the assembly: horizontal and vertical. In the horizontal configuration (FIGS. 1 and 2), the second end 117 of the stand pole 105 is received within the axial bore 129. The stand base 101 can then be positioned on a substantially horizontal surface for operation of the tracking camera assembly 100, for example being mounted on a counter top. In the vertical configuration (FIG. 3), the second end 117 of the stand pole 105 is received within the radial bore 131. The stand base 101 can then be positioned on a vertical or at least angled surface for operation of the tracking camera assembly 100, for example being attached to a wall or a television.

### REMARKS

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

1. A tracking camera assembly comprising:
a camera head;
a stand pole extending away from the camera head;
a stand base configured to receive the stand pole, the stand base comprising:
a cylindrical body having an upper surface, a lower surface, and a side surface, the cylindrical body defining an axis extending between the upper surface and the lower surface;
an axial bore formed in the top surface of the cylindrical body and extending substantially parallel to the axis, the axial bore configured to removably receive a portion of the stand pole therein when the stand pole is in a first position relative to the cylindrical body;
a radial bore formed in the side surface of the cylindrical body and extending substantially perpendicularly to the axis, the radial bore configured to removably receive a portion of the stand pole therein when the stand pole is in a second position relative to the cylindrical body, the second position different than the first position; and
a recess formed in the bottom surface of the cylindrical body, the recess configured to receive an adhesive therein,
wherein the stand pole is configured to freely rotate with respect to the stand base when removably received within the axial bore without changing its longitudinal position with respect to the stand base, and
wherein the camera is configured to pivot about a lateral axis with respect to a top of the stand pole.

2. (canceled)

3. (canceled)

4. The tracking camera assembly of claim 1 further comprising a double-sided adhesive tape disposed in the recess.

5. The tracking camera assembly of claim 1 wherein the axial bore and the radial bore are each blind holes.

6. The tracking camera assembly of claim 1 wherein the axial bore is a through-hole.

7. The tracking camera assembly of claim 1 wherein the axial bore and the radial bore are each configured to removably receive a portion of the stand pole therein via friction fit.

8. The tracking camera assembly of claim 1 wherein the camera head is configured to move with respect to the stand pole with at least two degrees of freedom.

9. (canceled)

10. The tracking camera assembly of claim 1 wherein the stand pole is configured to rotate with respect to the stand base when removably received within the radial bore.

11. A tracking camera assembly comprising:
a camera head;
a support member extending away from the camera head;
a stand base configured to receive the support member, the stand base comprising:
an upper surface, a lower surface, and a side surface extending between the upper surface and the lower surface;
a first bore formed in the upper surface and configured to removably receive a portion of the support member therein;
a second bore formed in the side surface and configured to removably receive a portion of the support member therein,
wherein the support member is configured to freely rotate with respect to the stand base when removably received within the first bore without changing its longitudinal position with respect to the stand base, and
wherein the camera head is configured to pivot about a lateral axis with respect to a top of the support member.

12. The tracking camera assembly of claim 11 wherein the stand base is disc-shaped.

13. The tracking camera assembly of claim 11 wherein the support member comprises an elongated rod.

14. The tracking camera assembly of claim 11, further comprising a recess formed in the bottom surface configured to receive an adhesive therein.

15. (canceled)

16. The tracking camera assembly of claim 11 wherein the first bore and the second bore are each configured to removably receive a portion of the support member therein via friction fit.

17. A method of assembling a tracking camera assembly, the method comprising:
positioning a stand base, the stand base comprising:
an upper surface, a lower surface, and a side surface extending between the upper surface and the lower surface;
an axial bore formed in the upper surface; and
a radial bore formed in the side surface;
coupling a first end portion of a stand pole to the stand base, wherein the stand pole is configured to freely rotate with respect to the stand base when coupled to the stand base; and
coupling a second end portion of the stand pole to a camera head, wherein the camera head is configured to pivot about a lateral axis with respect to the second end portion of the stand pole.

18. The method of claim 17 wherein coupling the first end of the stand pole to the stand base comprises inserting the first end of the stand pole into the axial bore.

19. The method of claim 17 wherein coupling the first end of the stand pole to the stand base comprises inserting the first end of the stand pole into the radial bore.

20. The method of claim 17 further comprising attaching an adhesive on the lower surface of the stand base.
